(19) United States
(12) Patent Application Publication
(10) Pub. No.: US 2008/0198414 A1
(43) Pub. Date: Aug. 21, 2008

(54) Image forming apparatus and image forming method

(75) Inventors: Masahiro Ozawa, Tokyo (JP); Yoshinori Tanaka, Tokyo (JP); Hiroshi Nogawa, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/802,744

(22) Filed: May 24, 2007

(30) Foreign Application Priority Data
Feb. 15, 2007 (JP) 2007-034979

(51) Int. Cl. G06K 15/00

(52) U.S. Cl. 358/1.17; 358/1.9

(57) ABSTRACT

Disclosed is an image forming apparatus including: a memory unit having a common storage area which temporarily stores intermediate data between page description language data and bitmap data, and the bitmap data generated based on the intermediate data, and which includes a rasterization area used when the bitmap data are generated based on the intermediate data and temporarily stored therein; a control unit which generates the bitmap data form based on the intermediate data and temporarily stores in the rasterization area; an image processing unit which executes image processing on the bitmap data stored in the rasterization area by the control unit, and which stores the image-processing completed bitmap data in the storage area; and a memory area control section which expands the rasterization area according to a used state of the rasterization area.

### CROSS-REFERENCE TO RELATED APPLICATION(S)

The present U.S. patent application claims a priority under the Paris Convention of Japanese patent application No. 2007-034979 filed on Feb. 15, 2007, and is entitled to the benefit thereof for a basis of correction of an incorrect translation.

### BACKGROUND OF THE INVENTION

1. Field of the Invention

The present invention relates to an image forming apparatus and an image forming method, which stores data in a form of page description language (PDL) in a memory.

2. Description of Related Art

Recently, there has been widely used an image forming apparatus, such as a network type copier, printer, or MFP (multifunction peripherals), which receives print data, namely, data in a form of page description language (PDL) produced by an external device, e.g., a PC (personal computer) through a network, e.g., a LAN, produces data in an intermediate form (intermediate data) based on the received data to temporarily store in a memory, reads the stored intermediate data sequentially to generate bitmap data, and then prints out. The PDL typically includes PostScript™ and PCL (printer control language).

Such an image forming apparatus has a common storage area in which an area that is used for generating and temporarily storing intermediate data, and an area that is used for generating and temporarily storing bitmap data, coexist.

Bitmap data generated based on the intermediate data are generated by a rasterizing process. The rasterizing process includes generating bitmap data from the intermediate data band by band (band bitmap data) to temporarily store into the common storage area, reading the band bitmap data from the common storage area, applying image processing such as a color conversion process and a screen process, compressing the data after the image processing, and storing the compressed bitmap data into the common storage area.

That is, the rasterizing process includes a first generating process to generate the band bitmap data from the intermediate data, and a second generating process to apply image processing and compression processing to the generated band bitmap data.

The first and the second generating processes are independent processes of each other, and can be executed in parallel. Accordingly, the first generating process is executed by using a CPU (central processing unit), the second generating process is executed by using an LSI (large scale integrated circuit), and two areas are secured for storing the band bitmap data generated by the first generating process (the area hereinafter referred to as a “rasterization band”) in the common storage area. Thus, the first and the second generating processes are executed in parallel to achieve effective processing.

Time for transferring the band bitmap data from the common storage area to the LSI to execute the second generating process (transfer speed) and time necessary for executing the image processing and the compression processing of the second generating process by the LSI are almost constant, whereas time necessary for executing the first generating process by the CPU varies according to the content of the intermediate data.

When the intermediate data are light as a load, the first generating process is executed for a short time. Therefore, for example, when band bitmap data of a rasterization band at one side are in the midst of transfer and band bitmap data of a rasterization band at the other side wait for completion of the transfer, the CPU goes into a standby state when trying to execute the first generating process, because generated band bitmap data cannot be stored.

On the contrary, when the intermediate data are heavy as a load, time for executing the first generating process becomes long. Therefore, for example, when the CPU is generating band bitmap data in a rasterization band at one side and a rasterization band at the other side is empty, there is no band bitmap data transferable from the common storage area to the LSI, so that the LSI cannot execute the second generating process and goes into a standby state.

As described above, the time for the CPU to execute the first generating process varies according to the content of intermediate data. This leads to a problem in that execution efficiency of the rasterizing process is reduced and throughput is lowered.

An image forming apparatus is disclosed as a technique to improve efficiency of data development processing (For example, refer to Japanese Laid-Open Patent Publication No. H07-195760). This apparatus includes a means for developing command data into bitmap data in a band unit, and a band memory for storing the developed bitmap data in the band unit. By analyzing the command data, development time for bitmap data by each band is calculated, and the calculated development time is compared with a possible development time. When the calculated development time is shorter than the possible development time, a band size is made smaller to thereby shorten the development time for bitmap data in the band unit.

However, in the conventional apparatus described above, a total capacity of a rasterization band is not changed, and therefore a transfer time of the band bitmap data is merely shortened. This still leads to a problem in that the execution efficiency of the rasterizing process cannot be improved and lowering of throughput cannot be avoided.

### SUMMARY

The present invention has been made to solve the above problems. An object of the present invention is to provide an image forming apparatus and an image forming method, which can improve execution efficiency of a rasterizing process and also improve the throughput.

In order to achieve the above object, according to one aspect of the present invention, an image forming apparatus comprises: a memory unit having a common storage area which temporarily stores data in an intermediate form between data in a form of page description language and data in a bitmap form, and the data in a bitmap form generated based on the data in an intermediate form, and which includes a rasterization area used when the data in a bitmap form are generated based on the data in an intermediate form and temporarily stored therein; a control unit which generates the data in a bitmap form based on the data in an intermediate form and temporarily stores in the rasterization area; an image processing unit which executes image processing on the data in a bitmap form stored in the rasterization area by the control unit, and which stores the image-processing completed bitmap data in the storage area; and a memory area control section which expands the rasterization area according to a used state of the rasterization area.

In the image forming apparatus, preferably, the memory area control section determines whether a usable area exists in the rasterization areas when generating the data in a bitmap form based on the data in an intermediate form, and expands the rasterization area according to a result of the determination.

In the image forming apparatus, preferably, the memory area control section determines whether it is possible for the image processing unit to execute image processing on the data in a bitmap form, and expands the rasterization area according to a result of the determination.

Preferably, in the image forming apparatus, the memory area control section releases, out of the expanded rasterization area, an expanded rasterization area portion in which the data in a bitmap form generated based on the data in an intermediate form are not stored.

In the image forming apparatus, preferably, the storage area includes the rasterization area in advance, and the memory area control section releases an expanded rasterization area portion when there exists, in the rasterization area included in advance, the rasterization area portion that does not store the data in a bitmap form generated based on the data in an intermediate form.

In the image forming apparatus, preferably, the memory area control section determines whether the image-processing executed data in a bitmap form can be stored in the storage area, and releases the expanded rasterization area according to a result of the determination.

Preferably, the control unit includes a CPU to execute a computer program, and the memory area control section is configured to be a part of the control unit as a function implemented with the computer program executed by the CPU.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a block diagram showing control in an image forming apparatus 1 according to an embodiment of the invention;

FIG. 2 is a diagram schematically illustrating a common storage area 123;

FIG. 3 is a flow diagram showing a procedure until an image for one page is formed on a recording medium;

FIG. 4 is a flowchart showing a procedure that CPU 100 executes in a rasterizing process at step S3;

FIG. 5 is a flowchart showing a procedure that an image processing unit 130 executes at step S16;

FIG. 6A is an example of a time chart for a conventional rasterizing process in which rasterization bands are not expanded, and FIG. 6B is an example of a time chart for the rasterizing process according to the embodiment of the invention; and

FIG. 7 is a flowchart showing a procedure that CPU 100 executes in a modified embodiment corresponding to FIG. 4.

### DETAILED DESCRIPTION OF THE PREFERRED EMBODIMENTS

Hereinafter, preferred embodiments of the invention will be described in detail with reference to the accompanying drawings.

First, the structure of an apparatus will be explained.

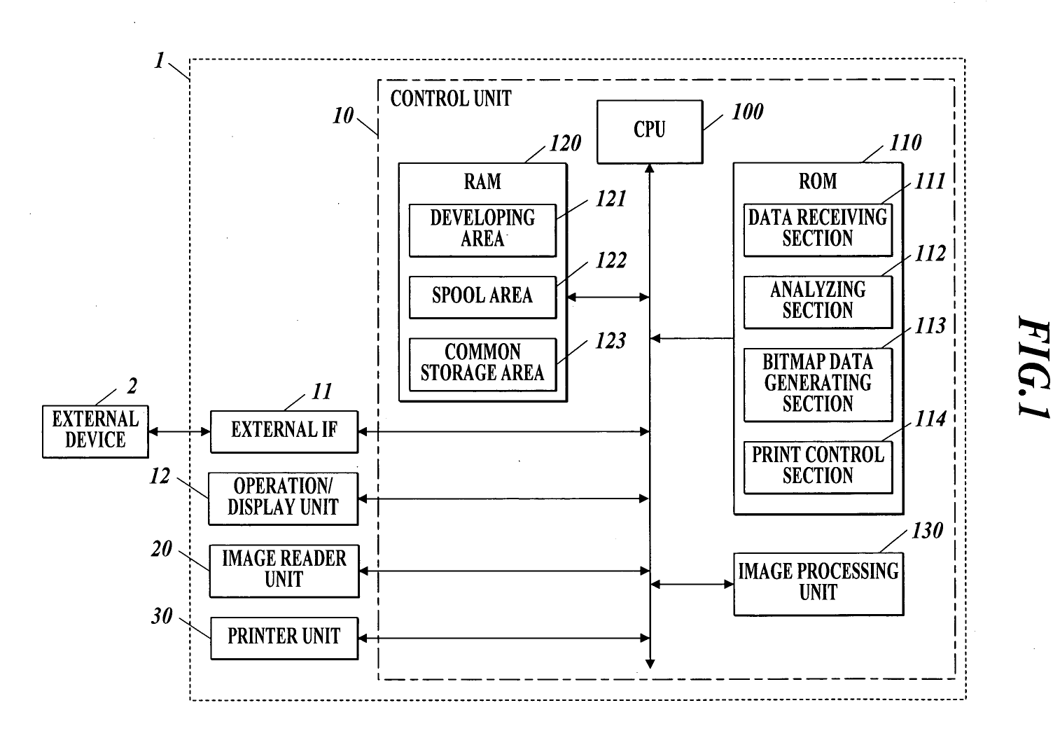

FIG. 1 shows a control block diagram of an image forming apparatus 1 according to the embodiment.

As shown in FIG. 1, the image forming apparatus 1 includes a control unit 10, an external IF (interface) 11, an operation/display unit 12, an image reader unit 20 and a printer unit 30. Each element is connected with each other by a bus or the like, and can communicate with an external device 2 through the external IF 11.

The image forming apparatus 1 is a digital multifunction machine having a copying function, printing function and the like. The copying function reads an image from a document as a reading object (hereinafter referred to as a “document”), and forms an image on a recording medium, such as a sheet of paper as a processing object sheet, based on the read image. The printing function receives image data from the external device 2 such as a personal computer, forms an image on a recording medium based on the received image and outputs it.

The control unit (simply, “controller”) 10 includes CPU (central processing unit) 100, ROM (read only memory) 110 and RAM (random access memory) 120 and image processing unit 130, and develops various programs and data stored in the ROM 110 into the RAM 120 to perform centralized control for operation of each part of the image forming apparatus 1 based on the programs. For instance, according to a command signal input from the operation/display unit 12 or the external device 2, the controller 10 changes its operation mode to a copy mode, a print mode or a scanner mode, reads a processing program for each mode, and performs control of copying, printing or image data reading.

The CPU 100 interprets, in cooperation with ROM 110 and RAM 120, data in a form of page description language (hereinafter, “PDL data”), the PDL including PostScript™ and PCL, generates data in an intermediate form (hereinafter, “intermediate data”) between the PCL data and data in a bitmap form (hereinafter, “bitmap data”), and stores the data into a common storage area 123 in the RAM 120. Further, the CPU generates bitmap data by the band (hereinafter, “band bitmap data”) based on the intermediate data and stores the data into the common storage area 123 in the RAM 120, and also enables the image processing unit 130 to read the band bitmap data from the common storage area 123 and to execute image processing and compression processing. The band bitmap data, to which image processing has been applied and compressed by the image processing unit 130 (hereinafter, “compressed band bitmap data”), are stored in the common storage area 123.

Here, when storing the intermediate data and the band bitmap data, which differ from each other in forms, into the common storage area 123, the CPU 100 manages the storage of the intermediate data and the band bitmap data using threshold values.

The intermediate data are data generated according to features of objects (text data, graphics data, image data, etc.) included in PDL data. For instance, data in a form of vector may be used as the intermediate data for text data and graphics data, and data in a form of image as the intermediate data for image data.

Further, when generating band bitmap data based on intermediate data, the CPU 100, in cooperation with the ROM 110 and the RAM 120, determines whether there exists a usable area in rasterization areas included in the common storage area 123 (hereinafter, “rasterization bands”), which will be explained in detail later, and expands and secures a rasterization area according to the determination result.

Furthermore, when there exists, in the common storage area 123, a predetermined rasterization band (hereinafter, “fixed rasterization band”) where band bitmap data generated based on intermediate data are not stored, and there also exists an expanded rasterization band where band bitmap data generated based on intermediate data are not stored out of expanded rasterization bands, the expanded rasterization band, in which band bitmap data generated based on intermediate data are not stored, is released.

Additionally, CPU 100, in cooperation with ROM 110 and RAM 120, determines whether compressed band bitmap data, to which image processing and compression processing have been applied by the image processing unit 130, could be stored in the common storage area 123, and releases the expanded rasterization band in which band bitmap data are not stored, according to the determination result.

The ROM 110 stores various processing programs associated with image formation, data associated with image formation, and data to be processed by the various programs. The ROM 110 includes a data receiving section 111, an analyzing section 112, a bitmap data generating section 113 and a print control section 114, which store programs and data for implementing the present embodiment in cooperation with CPU 100 and RAM 120.

The data receiving section 111 stores programs and data for implementing a function of receiving PDL data from the external device 2 through the external IF 11 and storing the data into a spool area 122 in the RAM 120.

The analyzing section 112 stores programs and data for implementing a function of reading the PDL data stored in the spool area 122 in RAM 120, generating intermediate data in a form between the read PDL data and bitmap data, and storing the intermediate data into the common storage area 123 of ROM 120.

The bitmap data generating section 113 stores programs and data for implementing a function of generating band bitmap data by applying a rasterizing process to the intermediate data generated by the analyzing section 112 and stored in the common storage area 123, temporarily storing the generated band bitmap data into the rasterization band in the common storage area 123, expanding a rasterization band, or releasing the expanded rasterization band. Further, when compressed band bitmap data generated by the image processing unit 130 have been stored into the common storage area 123, the bitmap data generating section 113 deletes the intermediate data corresponding to the stored compressed band bitmap data from the common storage area 123.

The print control section 114 stores programs and data for implementing a function of decompressing the compressed band bitmap data generated by the image processing unit 130 and outputting to the printer unit 30 for forming an image on a recording medium such as a paper sheet, and deleting the output compressed band bitmap data.

The ROM 110 may be configured by a magnetic or optical storage medium or a semiconductor memory as long as it is a readable and nonvolatile storage medium. Further, the ROM 110 may be fixedly mounted on a control board, or detachably mounted.

The RAM 120 includes a developing area 121, the spool area 122 and the common storage area 123 for storing data associated with image formation, data processed by various programs and the like.

The developing area 121 is an area in which various programs and data stored in the ROM 110 are developed, and which stores various data produced with execution of various programs and data.

The spool area 122 stores various data, such as PDL data input from the external device 2 or the image reader unit 20.

The common storage area 123 is a common storage area that temporarily stores intermediate data generated in cooperation with CPU 100, ROM 110 and RAM 120, band bitmap data generated based on the intermediate data, and compressed bitmap data generated by the image processing unit 130, the area 123 including rasterization bands which are used when the band bitmap data are generated based on the intermediate data and temporarily stored therein.

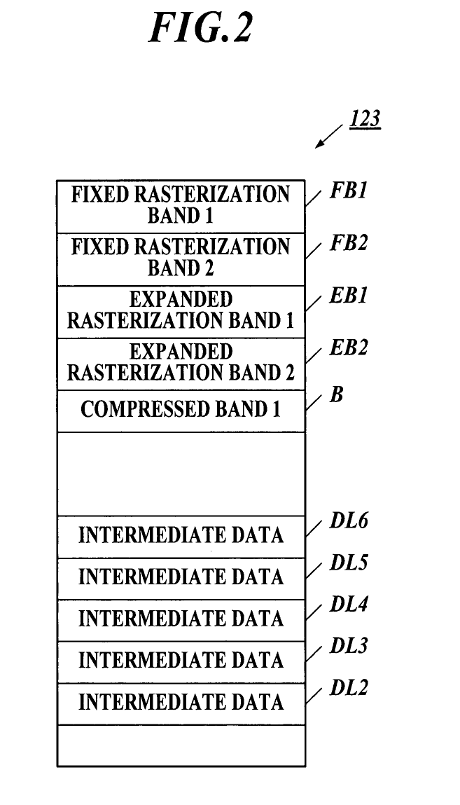

FIG. 2 schematically shows one example of the common storage area 123.

Referring to FIG. 2, the rasterization bands are divided into fixed rasterization bands FB1 and FB2 that are included in the common storage area 123 in advance, and expanded rasterization bands EB1 and EB2 that are appropriately expanded. The fixed rasterization bands FB1 and FB2 and the expanded rasterization bands EB1 and EB2 are areas having predetermined sizes.

In order to execute in parallel processing by CPU 100 with the bitmap-data generating section 113 and processing by the image processing unit 130, the common storage area 123 includes two or more fixed rasterization bands FB1 and FB2 in advance. The embodiment is described on the premise that two fixed rasterization bands FB1 and FB2 are included as shown in FIG. 2.

The common storage area 123 stores rasterization bands FB1, FB2, EB1, EB2, where band bitmap data are stored, and compressed band bitmap data B from upper addresses toward lower addresses thereof, and also stores intermediate data DL2-DL6 from lower addresses toward upper addresses thereof.

In the common storage area 123, if areas capable of storing intermediate data, rasterization bands and compressed band bitmap data, are respectively admitted without limitation therein, processing would go into a deadlock of unprintable state when there is no room to store compressed band bitmap data. In order to avoid this deadlock state, while rasterization bands and compressed band bitmap data are permitted to be stored in the common storage area 123 without limitation, intermediate data are restricted to be stored with use of threshold values.

Incidentally, the RAM 120 may be configured with, but not limited to, an HDD (hard disk drive), an MRAM (magnetic random access memory), a flash memory or the like, as long as it is a readable-writable storage medium. The RAM 120 may be fixedly mounted on a control board, or detachably mounted.

The image processing 130 reads out band bitmap data stored in a rasterization band of the common storage area 123, executes various image processing such as a color conversion process and a screen process, compresses the processed data, and stores the compressed band bitmap data into the common storage area 123. The image processing 130 is configured including an LSI (large scale integrated circuit) for executing preset image processing and compression processing.

The external IF 11 is a communication interface, such as a NIC (network interface card) or a modem, for connecting to a network N, e.g., a LAN, and receives PDL data and the like from the external device 2. The received PDL data and the like are output to the controller 10.

The operation/display unit 12 includes an LCD (liquid crystal display), a touch panel mounted to cover the LCD, and an operation key group. Various setting screens, which are provided for inputting various setting conditions, and various processed results are displayed on the LCD according to display signals input from the controller 10. Operation signals, which are input from the operation key group or the touch panel, are output to the controller 10.

The image reader unit 20 has an automatic document feeding part, and a reader part.

The automatic document feeding part is called an ADF (auto document feeder), which feeds documents stacked on a document tray to the reader part sheet by sheet.

The reader part is constructed as a scanner having a light source, lenses, contact glass, image sensor, etc. The image on the document is read such that reflected light of the light irradiating the document is converged and converted photo-electrically, and output to the printer unit 30. Here, the image includes not only image data, e.g., pictures and photographs, but also text data, e.g., characters and symbols.

The printer unit 30 includes an image forming section that employs an electro-photographic system, and a feeding/conveying section that conveys a recording medium fed from a paper feeding section to the image forming section. The image forming section forms a color image depending on image data including four colors of yellow (Y), magenta (M), cyan (C) and black (K), and transfers the color image onto the recording medium conveyed by the feeding/conveying section.

Next, the operation of the embodiment will be described.

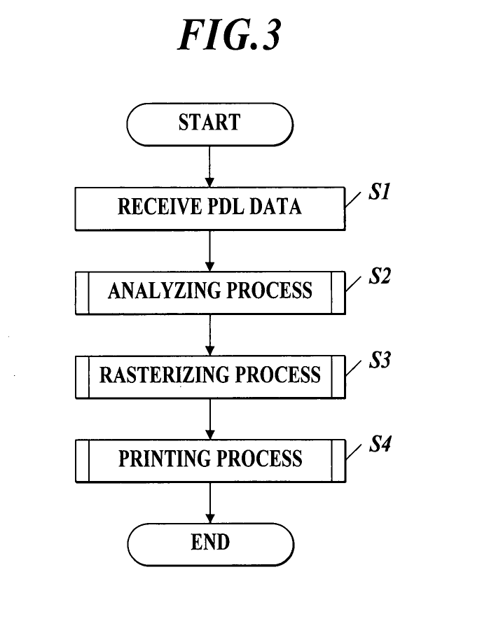

FIG. 3 is a flow diagram showing a procedure until an image for one page is formed on a recording medium. The operations shown in FIG. 3 are executed in cooperation with CPU 100, ROM 110 and RAM 120. Incidentally, process modules executed by the following steps S1-S4 can be operated in a multitask manner and plural pages can be processed in parallel, but these steps S1-S4 will be explained in a time sequential manner for explanatory convenience.

Based on the data receiving section 111, CPU 100 receives PDL data input through the external interface 11 and stores the data into the spool area 122, thus executing a data receiving process (step S1).

After the PDL data is stored into the spool area 122, based on the analyzing section 112, CPU 100 reads out the PDL data stored in the spool area 122, generates intermediate data and stores into the common storage area 123, thus executing an analyzing process (step S2).

Depending on the bitmap data generating section 113, when intermediate data of one page is stored in the common storage area 123, CPU 100 generates band bitmap data based on the intermediate data of one page stored in the common storage area 123 and stores the generated data into a rasterization band. Thereafter, the image processing unit 130 reads out the band bitmap data from the rasterization band, executes various image processing and compression processing, and stores the compressed band bitmap data into the common storage area 123, thus generating the compressed band bitmap data of one page. That is, depending on the bitmap data generating section 113, the rasterizing process is executed with processing by the CPU 100 and processing by the image processing unit 130 (step S3).

Depending on the print control section 114, when the compressed band bitmap data of one page are stored into the common storage area 123, CPU 100 reads out the compressed band bitmap data of one page from the common storage area 123, decompresses the read data, outputs the decompressed band bitmap data to the printer unit 30, and forms an image of one page onto a recording medium (step S4), thus the procedure ends.

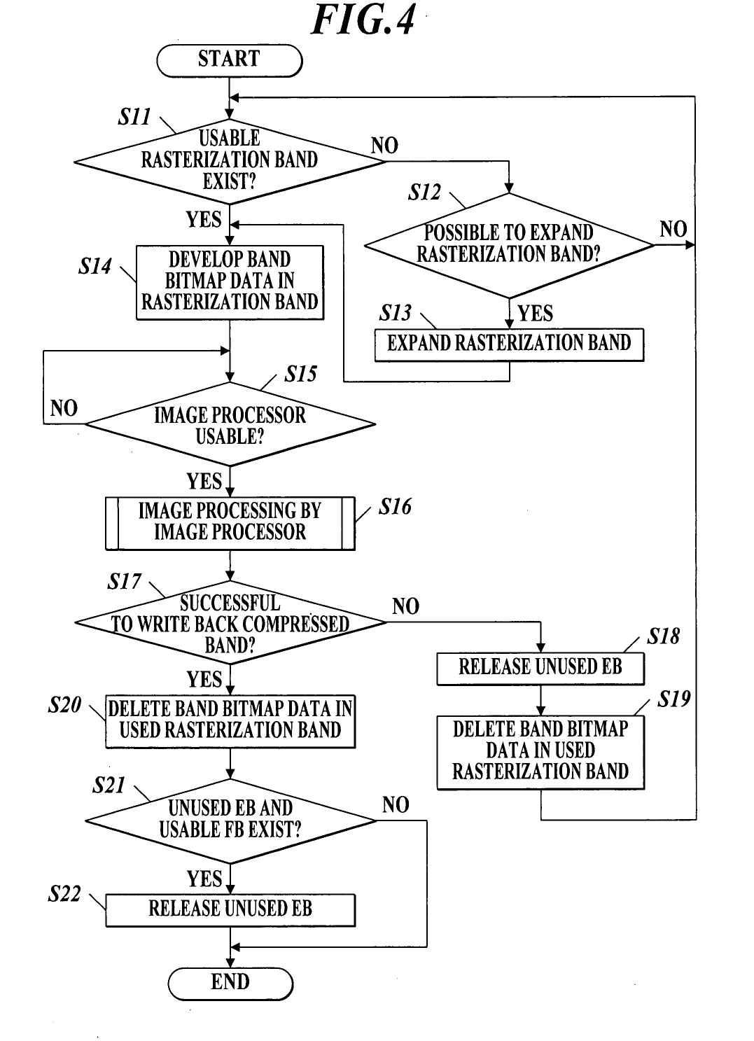

FIG. 4 shows a flowchart of a procedure that CPU 100 executes in the rasterizing process at step S3. The processing shown in FIG. 4 is executed by CPU 100 depending on the bitmap data generating section 113. FIG. 4 is a diagram to explain a series of processes for generating band bitmap data of one band based on intermediate data of one band, and the processing shown in FIG. 4 is executed by CPU 100 on a plurality of bands that are simultaneously executable in a parallel manner, which will be explained later.

CPU 100 determines whether there exists a usable rasterization band in the common storage area 123 for generating band bitmap data of one band (step S11). Here, the usable rasterization band means a fixed rasterization band or an expanded rasterization band in which band bitmap data are not stored and which is not used for generating band bitmap data.

In this processing, the fixed rasterization band and the expanded rasterization band are generically called rasterization bands.

When CPU 100 determines that a usable rasterization band does not exists (“No” at step S11), then CPU 100 determines whether it is possible to expand a rasterization band (step S12).

When CPU 100 determines that it is impossible to expand a rasterization band, for example, there is no space area in the common storage area 123 for securing an expanded rasterization band (“No” at step S12), then the process returns to step S11.

When CPU 100 determines that it is possible to expand a rasterization band (“Yes” at step S12), then the rasterization band is expanded by securing one band of expanded rasterization band in the common storage area 123 (step S13).

When CPU 100 determines that a usable rasterization band exists (“Yes” at step S1) or after step S13, that is, after securing one expanded rasterization band usable for generating band bitmap data of one band in the common storage area 123, the band bitmap data is developed and generated based on the intermediate data in the secured expanded rasterization band and temporarily stored (step S14).

CPU 100 determines whether the image processing unit 130 is usable for processing the band bitmap data generated and stored in the rasterization band, that is, whether the image processing unit 130 is not in processing the band bitmap data generated and stored in the other rasterization band (step S15).

When CPU 100 determines that the image processing unit 130 is not usable for processing the band bitmap data generated and stored in the rasterization band, that is, the image processing unit 130 is in processing the band bitmap data generated and stored in the other rasterization band (“No” at step S15), the process returns to step S15 and continues to check.

When CPU 100 determines that the image processing unit 130 is usable for processing the band bitmap data generated and stored in the rasterization band, that is, the image processing unit 130 is not in processing the band bitmap data generated and stored in the other rasterization band (“Yes” at step S15), then the image processing unit 130 executes image processing and so forth on the band bitmap data (step S16).

In step S16, the image processing unit 130 applies image processing on the band bitmap data read from the rasterization band and thereafter compresses the processed data (compressed band bitmap data). CPU 100 determines whether the compressed band bitmap data have been successfully written back to the common storage area 123, that is, whether the compressed band bitmap data have been stored into the common storage area 123 (step S17).

When CPU 100 determines that the compressed band bitmap data have not been successfully written back to the common storage area 123, for example, the compressed band bitmap data could not be stored because there was not a space area to be stored (“No” at step S17), CPU 100 releases an unused expanded rasterization band, e.g., an expanded rasterization band in which band bitmap data are not stored or which is not used for generating band bitmap data (step S18).

The release of an expanded rasterization band at step S18 means that an unused expanded rasterization band, which is secured for generating and storing band bitmap data, is made to be a space area.

CPU 100 deletes the band bitmap data stored in the rasterization band used from step S14 on (step S19), and returns to step S11 to repeat the process.

When CPU 100 determines that the compressed band bitmap data have been written back to the common storage area 123, that is, the compressed band bitmap data have been stored into the common storage area 123 (“Yes” at step S17), CPU 100 deletes the band bitmap data stored in the rasterization band used after step S14 (step S20).

CPU 100 determines whether an unused expanded rasterization band exists and a usable fixed rasterization band exists (step S21).

In step S21, the unused expanded rasterization band means an expanded rasterization band in which band bitmap data are not stored or which is not used for generating band bitmap data. The usable fixed rasterization band means a fixed rasterization band in which band bitmap data are not stored and which is not used for generating band bitmap data.

When determined that an unused expanded rasterization band exists and a usable fixed rasterization band exists (“Yes” at step S21), then CPU 100 releases the unused expanded rasterization band, and the process completes.

When determined that an unused expanded rasterization band does not exist or a usable fixed rasterization band does not exist (“No” at step S21), then the process completes.

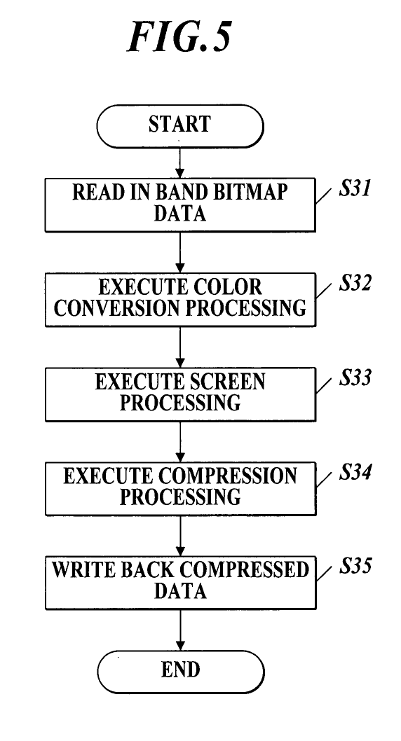

FIG. 5 shows a flowchart of a procedure that the image processing unit 130 executes in step S16. FIG. 5 shows processes for band bitmap data of one band.

The image processing unit 130 reads in band bitmap data generated and stored in a rasterization band within the common storage area 123 (step S31).

The image processing unit 130 executes a color conversion process (step S32) and a screen process (step S33) on the read-in band bitmap data. In the embodiment, the image processing is described including the color conversion process and the screen process, but other image processes may be applied.

In the color conversion process, for example, in order to agree the color of a document image with the color of the image to be output by the printer unit 30, RGB image signals output from the document image are converted into CMYK image signals for outputting to the printer unit 30 using a color conversion table. The screen process is a process for reproducing half-tone colors.

The image processing unit 130 executes compression processing on the band bitmap data, to which the color conversion process and the screen process have been applied, to generate compressed band bitmap data (step S34).

The image processing unit 130 writes back the generated compressed band bitmap data into the common storage area 123 to be stored (step S35), and the procedure completes. Even if the compressed data are not written back (not stored), the procedure ends.

The above-described procedure is executed for every band, and step S14 is a task that requires heaviest load on CPU 100. Accordingly, at the time of finishing the process at step S14 for a band, CPU 100 is substantially released from the processing of the band in view of its processing load, and starts executing a procedure for next band (the same procedure as in FIG. 4). Thus, CPU 100 executes the rasterizing processes for a plurality of bands in parallel.

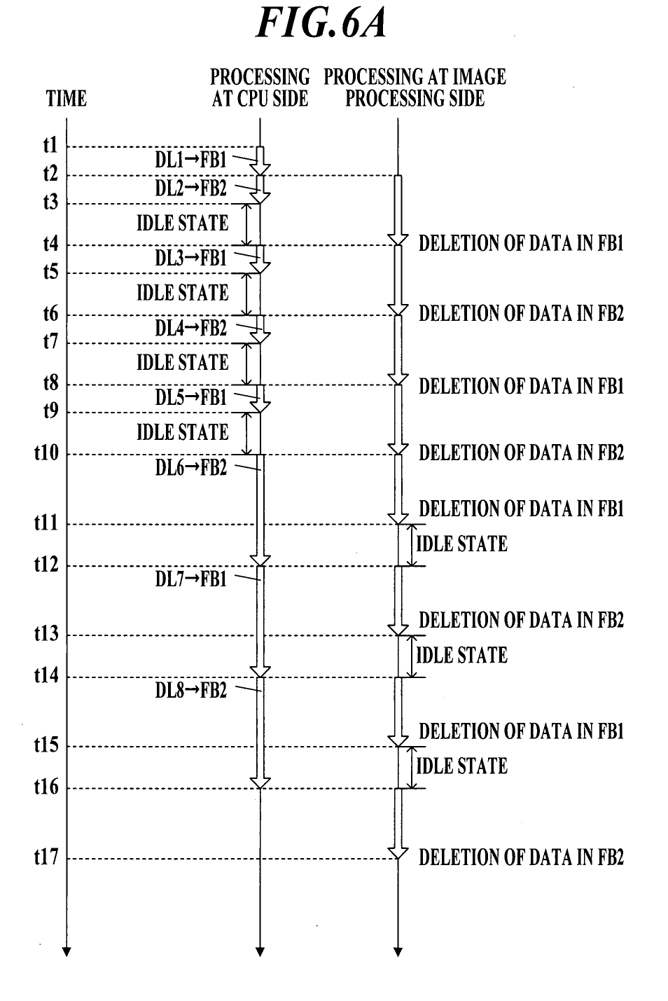

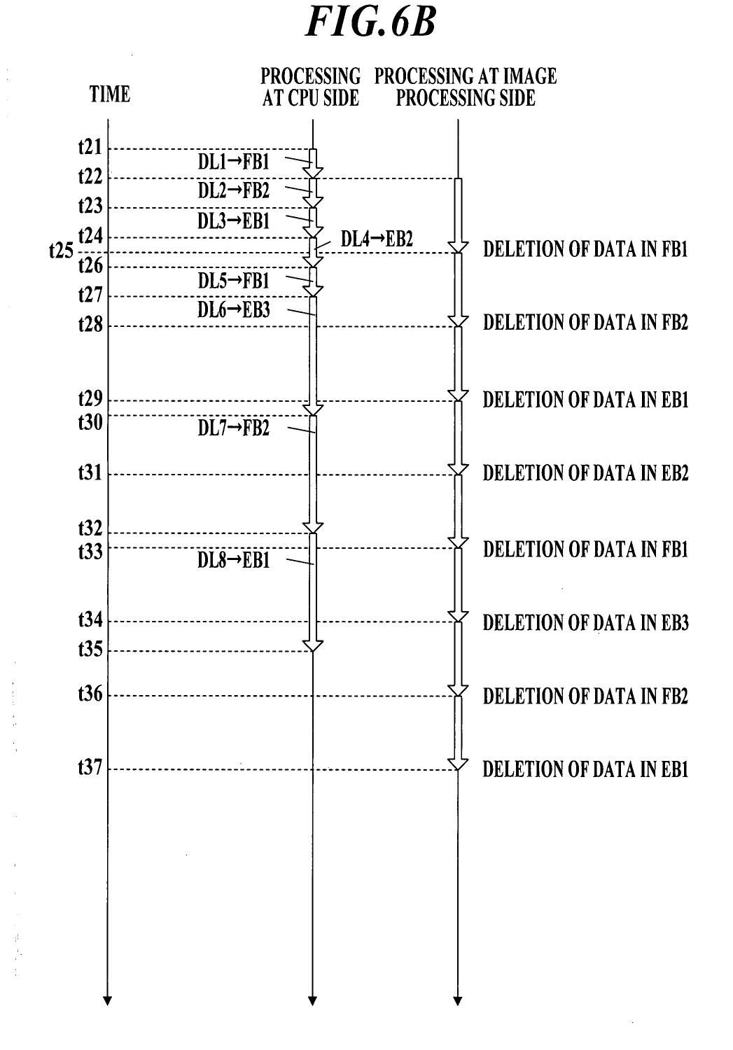

FIG. 6A shows an example of a time chart for a conventional rasterizing process in which rasterization bands are not expanded, and FIG. 6B shows an example of a time chart for the rasterizing process according to the embodiment.

As shown in FIGS. 6A and 6B, there are executed in parallel the generating process of band bitmap data by the CPU based on intermediate data and the image processing for the band bitmap data by the image processing unit.

Here, while a processing time by the CPU varies according to the content of intermediate data, a processing time by the image processing unit is constant because the content of image processing is set in advance. In FIGS. 6A and 6B, the length of an outlined arrow represents the time required for each process, DLn (n is a natural number) represents intermediate data, FBn (n is a natural number) a fixed rasterization band, and EBn(n is a natural number) an expanded rasterization band.

As shown in FIG. 6A, when intermediate data are light load, the following situation occurs: since the generating process of band bitmap data by the CPU based on the intermediate data is performed in a shorter time than the processing time of the image processing unit, while the image processing unit processes the band bitmap data generated and stored in one side of rasterization bands, another band bitmap data are generated and stored in the other side of rasterization bands and wait for transfer to the image processing unit. For example, in times t3-t4, t5-t6, t7-t8, and t9-t10 in FIG. 6A, since there is not a rasterization band for band bitmap data to be generated and stored therein, the CPU goes into an idle state (standby state) even when the CPU further tries to execute a generating process of band bitmap data based on other intermediate data.

Referring to FIG. 6A, when intermediate data are heavy load, the following situation occurs: since the generating process of band bitmap data by the CPU based on the intermediate data is performed in a longer time than the processing time of the image processing unit, while the band bitmap data is generated in one side of rasterization bands, the other side of rasterization bands is empty (a state that band bitmap data are not generated and not stored). For example, in times t11-t12, t13-t14, and t15-t16 in FIG. 6A, since there is not band bitmap data possible to be processed by the image processing unit in the rasterization bands, the image processing unit cannot execute image processing and goes into an idle state (standby state).

The rasterizing process of the embodiment will be explained with reference to FIG. 6B. Here, it is assumed that the common storage area 123 includes two fixed rasterization bands.

At a time t21, CPU 100 starts generating band bitmap data in a fixed rasterization band FB1 based on intermediate data DL1.

At a time t22, when the band bitmap data are generated and stored in the fixed rasterization band FB1, the image processing unit 130 starts image processing on the band bitmap data stored in the band FB1, and also CPU 100 starts generating band bitmap data in a fixed rasterization band FB2 based on intermediate data DL2.

At a time t23, the fixed rasterization band FB2 stores the band bitmap data generated based on the intermediate data DL2, and the fixed rasterization band FB1 is used by the image processing unit 130 for image processing on the band bit data stored therein, therefore there is no fixed rasterization band to be used for generating band bitmap data based on intermediate data DL3. Therefore, an expanded rasterization band EB1 is secured to start generating band bitmap data in the band EB1 based on the intermediate data DL3.

At a time t24, the image processing unit 130 is in the midst of image processing of the band bitmap data stored in the fixed rasterization band FB1, the fixed rasterization band FB2 stores the band bitmap data, and the expanded rasterization band EB1 stores the band bitmap data generated based on the intermediate data DL3, therefore there is no fixed rasterization band nor expanded rasterization band to be used for generating band bitmap data based on intermediate data DL4. Therefore, an expanded rasterization band EB2 is secured to start generating band bitmap data in the band EB2 based on the intermediate data DL4.

At a time t25, the image processing unit 130 completes the image processing of the band bitmap data stored in the fixed rasterization band FB1, generates compressed band bitmap data to store into the common storage area 123, and deletes the band bitmap data stored in the fixed rasterization band FB1. Further, the image processing unit 130 starts image processing on the bitmap data stored in the fixed rasterization band FB2.

At a time t26, when the band bitmap data are generated and stored in the expanded rasterization band EB2 based on the intermediate data DL4, since the fixed rasterization band FB1 does not store band bitmap data and is not used for generating bitmap data, CPU starts generating band bitmap data in the fixed rasterization band FB1 based on the intermediate data DL5.

At a time t27, the fixed rasterization band FB1 stores the band bitmap data generated based on the intermediate data DL5, the image processing unit 130 is in image processing of the band bitmap data stored in the fixed rasterization band FB2, and the expanded rasterization bands EB1 and EB2 store respective band bitmap data, therefore there is no fixed rasterization band nor expanded rasterization band to be used for generating band bitmap data based on intermediate data DL6. Therefore, an expanded rasterization band EB3 is secured to start generating band bitmap data in the band EB3 based on the intermediate data DL6.

At a time t28, the image processing unit 130 completes the image processing of the band bitmap data stored in the fixed rasterization band FB2, generates compressed band bitmap data to store into the common storage area 123, and deletes the band bitmap data stored in the fixed rasterization band FB2. Further, the image processing unit 130 starts image processing on the bitmap data stored in the expanded rasterization band EB1.

At a time t29, the image processing unit 130 completes the image processing of the band bitmap data stored in the expanded rasterization band EB1, generates compressed band bitmap data to store into the common storage area 123, and deletes the band bitmap data stored in the expanded rasterization band EB1. Further, the image processing unit 130 starts image processing on the band bitmap data stored in the expanded rasterization band EB2.

At a time t30, when the band bitmap data are generated and stored in the expanded rasterization band EB3 based on the intermediate data DL6, since the fixed rasterization band FB2 does not store band bitmap data and is not used for generating band bitmap data, CPU starts generating band bitmap data in the fixed rasterization band FB2 based on the intermediate data D7.

At a time t31, the image processing unit 130 completes the image processing of the band bitmap data stored in the expanded rasterization band EB2, generates compressed band bitmap data to store into the common storage area 123, and deletes the band bitmap data stored in the expanded rasterization band EB2. Further, the image processing unit 130 starts image processing on the bitmap data stored in the fixed rasterization band FB1.

At a time t32, the fixed rasterization band FB2 stores the band bitmap data generated based on the intermediate data DL7, the image processing unit 130 is in the midst of image processing of the band bitmap data stored in the fixed rasterization band FB1. However, the expanded rasterization band EB1 does not store band bitmap data and is not used for generating band bitmap data. Therefore, CPU starts generating band bitmap data in the expanded rasterization band EB1 based on the intermediate data DL8.

At a time t33, the image processing unit 130 completes the image processing of the band bitmap data stored in the fixed rasterization band FB1, generates compressed band bitmap data to store into the common storage area 123, and deletes the band bitmap data stored in the fixed rasterization band FB1. Further, the image processing unit 130 starts image processing on the bitmap data stored in the expanded rasterization band EB3.

At a time t34, the image processing unit 130 completes the image processing of the band bitmap data stored in the expanded rasterization band EB3, generates compressed band bitmap data to store into the common storage area 123, and deletes the band bitmap data stored in the expanded rasterization band EB3. Further, the image processing unit 130 starts image processing on the bitmap data stored in the fixed rasterization band FB2.

At a time t35, the band bitmap data are generated and stored in the expanded rasterization band EB1 based on the intermediate data DL8.

At a time t36, the image processing unit 130 completes the image processing of the band bitmap data stored in the fixed rasterization band FB2, generates compressed band bitmap data to store into the common storage area 123, and deletes the band bitmap data stored in the fixed rasterization band FB2. Further, the image processing unit 130 starts image processing on the bitmap data stored in the expanded rasterization band EB1.

At a time t37, the image processing unit 130 completes the image processing of the band bitmap data stored in the expanded rasterization band EB1, generates compressed band bitmap data to store into the common storage area 123, and deletes the band bitmap data stored in the expanded rasterization band EB1.

As shown in FIG. 6B, according to the embodiment, the CPU 100 and the image processing unit 130 can be prevented from going into respective idle states, and therefore the time necessary for the rasterizing process can be shortened than that of the conventional case shown in FIG. 6A.

According to the embodiment, rasterization bands can be expanded according to existence of a usable rasterization band when generating band bitmap data, therefore there can be appropriately secured a rasterization band to be used when generating band bitmap data based on intermediate data. Resultantly, the CPU 100 does not need to stand by until a rasterization band to be used when generating band bitmap data becomes empty. This allows improvement of execution efficiency of a rasterizing process even when a processing time by CPU 100 varies according to the content of intermediate data, and allows improvement of the throughput.

Further, when there exists a fixed rasterization band where band bitmap data are not stored, and also exists an expanded rasterization band where band bitmap data are not stored (that is, an unused expanded rasterization band), the unused expanded rasterization band can be released. The release of the unnecessary expanded rasterization band allows preventing overflow of the common storage area 123 and achieving effective use of the storage area.

Further, when compressed band bitmap data cannot be stored and there exists an expanded rasterization band where band bitmap data are not stored (that is, an unused expanded rasterization band), the unused expanded rasterization band can be released. Accordingly, there can be reduced disturbance of storing the compressed band bitmap data caused by expansion of rasterization bands.

### [Modification]

Hereinafter, a modification of the embodiment will be explained.

The modified embodiment is similar to the above-described embodiment with the exception that operations differ when expanding a rasterization band, and therefore a difference only will be described. Specifically, the difference is a part of the procedure shown in FIG. 4 that CPU 100 executes.

In the modification, CPU 100 implements a function as a memory-area controller in cooperation with ROM 110 and RAM 120, the controller determining whether the image processing unit 130 can execute image processing on band bitmap data, and expanding a rasterization band according to the result of the determination.

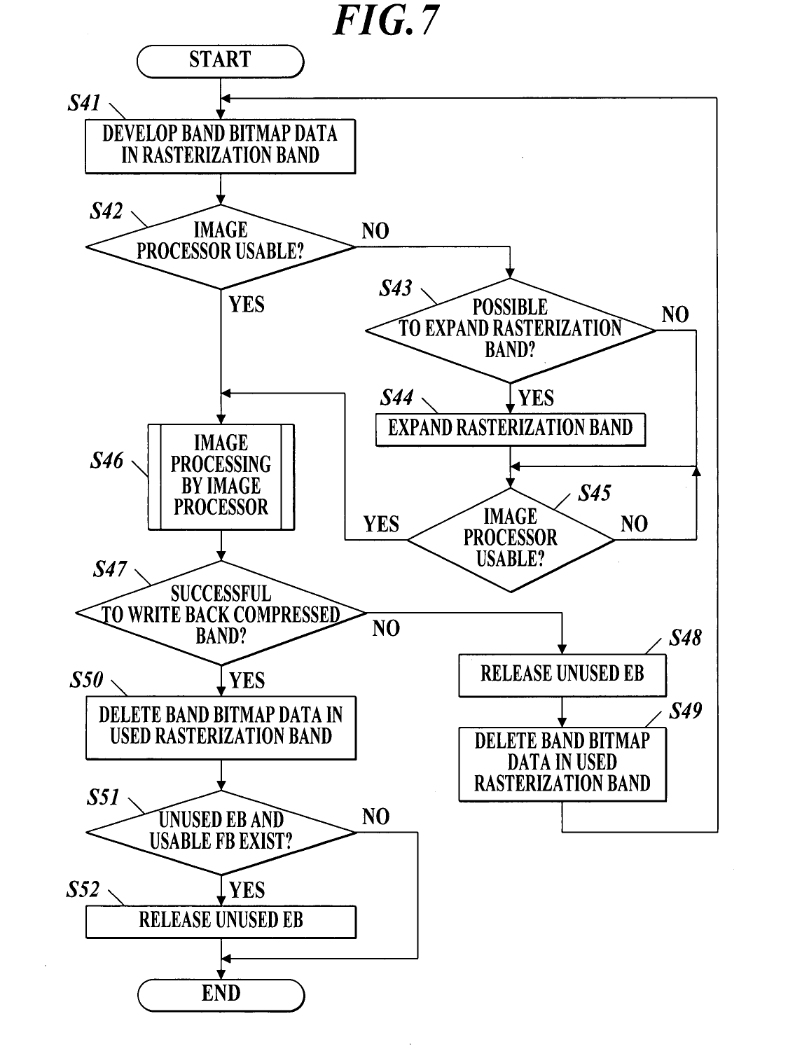

FIG. 7 shows a flowchart of a procedure that CPU 100 executes in the modified embodiment corresponding to FIG. 4.

CPU 100 develops and generates band bitmap data in a rasterization band based on intermediate data, and stores the data temporarily (step S41).

CPU 100 determines whether the image processing unit 130 is usable for processing the band bitmap data generated and stored in the rasterization band, that is, whether the image processing unit 130 is not in the midst of processing the band bitmap data generated and stored in the other rasterization band (step S42).

When CPU 100 determines that the image processing unit 130 is usable for processing the band bitmap data generated and stored in the rasterization band, that is, the image processing unit 130 is not in the midst of processing the band bitmap data generated and stored in the other rasterization band (“Yes” at step S42), then the process proceeds to step S46.

When CPU 100 determines that the image processing unit 130 is not usable for processing the band bitmap data generated and stored in the rasterization band, that is, the image processing unit 130 is in the midst of processing the band bitmap data generated and stored in the other rasterization band (“No” at step S42), then CPU 100 determines whether it is possible to expand a rasterization band (step S43).

When CPU 100 determines that the rasterization band is possible to expand (“Yes” at step S43), then the rasterization band is expanded by securing one band of expanded rasterization band in the common storage area 123 (step S44).

When CPU 100 determines that the rasterization band is impossible to expand, for example, there is no space area in the common storage area 123 for securing an expanded rasterization band (“No” at step S43), then the process proceeds to step S45.

Following “No” at step S43 or step S44, CPU 100 determines whether the image processing unit 130 is usable for processing the band bitmap data generated and stored in the rasterization band (step S45).

When not (“No” at step S45), the process returns to step S45 and continues to check.

When CPU 100 determines that the image processing unit 130 is usable for processing the band bitmap data generated and stored in the rasterization band, that is, the image processing unit 130 is not in processing the band bitmap data generated and stored in the other rasterization band (“Yes” at step S45), then the process proceeds to step S46.

Steps S46 through S52 are the same as steps S16 through S22 shown in FIG. 4, and the description thereof is omitted.

According to the modified embodiment, a rasterization band can be expanded according to whether the image processing unit 130 is usable for processing the band bitmap data. Therefore, CPU 100 can secure a rasterization band to be used when generating band bitmap data based on intermediate data without waiting for completion of image processing of the band bitmap data by the image processing unit 130. Resultantly, the CPU 100 does not need to stand by until a rasterization band to be used when generating band bitmap data becomes empty. This allows improvement of execution efficiency of a rasterizing process even when a processing time by CPU 100 varies according to the content of intermediate data, and allows improvement of the throughput.

The above-described procedure is executed for every band. Similarly to the embodiment described before, at the time of finishing the process at step S41 for a band, CPU 100 starts executing a procedure for next band (the same procedure as in FIG. 7).

What is claimed is:

1. An image forming apparatus comprising:
a memory unit having a common storage area which temporarily stores data in an intermediate form between data in a form of page description language and data in a bitmap form, and the data in a bitmap form generated based on the data in an intermediate form, and which includes a rasterization area used when the data in a bitmap form are generated based on the data in an intermediate form and temporarily stored therein;
a control unit which generates the data in a bitmap form based on the data in an intermediate form and temporarily stores in the rasterization area;
an image processing unit which executes image processing on the data in a bitmap form stored in the rasterization area by the control unit, and which stores the image-processing completed bitmap data in the storage area; and
a memory area control section which expands the rasterization area according to a used state of the rasterization area.

2. The image forming apparatus of claim 1, wherein the memory area control section determines whether a usable area exists in the rasterization areas when generating the data in a bitmap form based on the data in an intermediate form, and expands the rasterization area according to a result of the determination.

3. The image forming apparatus of claim 1, wherein the memory area control section determines whether it is possible for the image processing unit to execute image processing on the data in a bitmap form, and expands the rasterization area according to a result of the determination.

4. The image forming apparatus of claim 1, wherein the memory area control section releases, out of the expanded rasterization area, an expanded rasterization area portion in which the data in a bitmap form generated based on the data in an intermediate form are not stored.

5. The image forming apparatus of claim 4,
wherein the storage area includes the rasterization area in advance, and
the memory area control section releases an expanded rasterization area portion when there exists, in the rasterization area included in advance, the rasterization area portion that does not store the data in a bitmap form generated based on the data in an intermediate form.

6. The image forming apparatus of claim 4, wherein the memory area control section determines whether the image-processing executed data in a bitmap form can be stored in the storage area, and releases the expanded rasterization area according to a result of the determination.

7. The image forming apparatus of claim 1,
wherein the control unit includes a CPU to execute a computer program, and
the memory area control section is configured to be a part of the control unit as a function implemented with the computer program executed by the CPU.

8. An image forming method comprising:
a rasterization step to generate data in a bitmap form based on data in an intermediate form and to store the data in a bitmap form in a rasterization area of a memory unit, the memory unit having a common storage area which temporarily stores the data in an intermediate form between data in a form of page description language and data in a bitmap form, and the data in a bitmap form generated based on the data in an intermediate form, and which includes a rasterization area used when the data in a bitmap form are generated based on the data in an intermediate form and temporarily stored therein;
an image processing step to execute image processing on the data in a bitmap form stored in the rasterization area in the rasterization step, and which stores the image-processing completed bitmap data in the storage area; and
a memory area control step to expand the rasterization area according to a used state of the rasterization area.

9. The image forming method of claim 8, wherein the memory area control step determines whether a usable area exists in the rasterization areas when generating the data in a bitmap form based on the data in an intermediate form, and expands the rasterization area according to a result of the determination.

10. The image forming method of claim 8, wherein the memory area control step determines whether it is possible for the image processing unit to execute image processing on the data in a bitmap form, and expands the rasterization area according to a result of the determination.

11. The image forming method of claim 8, wherein the memory area control step releases, out of the expanded rasterization area, an expanded rasterization area portion in which the data in a bitmap form generated based on the data in an intermediate form are not stored.

12. The image forming method of claim 11, wherein the storage area includes the rasterization area in advance, and
the memory area control step releases an expanded rasterization area portion when there exists, in the rasterization area included in advance, the rasterization area portion that does not store the data in a bitmap form generated based on the data in an intermediate form.

13. The image forming method of claim 11, wherein the memory area control step determines whether the image-processing executed data in a bitmap form can be stored in the storage area, and releases the expanded rasterization area according to a result of the determination.
